(19) United States
(12) Patent Application Publication
(10) Pub. No.: US 2005/0170119 A1
(43) Pub. Date: Aug. 4, 2005

(54) Multi-layer plastic conduit comprising a PVC layer

(75) Inventors: Helmut Kirchner, Konigsberg (DE); Otto Kirchner, Konigsberg (DE)

Correspondence Address: BURNS DOANE SWECKER & MATHIS L L P, POST OFFICE BOX 1404, ALEXANDRIA, VA, 22313-1404, US

(73) Assignee: Frankische Rohrwerke Gebr. Kirchner Gmbh + Co KG

(21) Appl. No.: 10/976,000

(22) Filed: Oct. 29, 2004

(30) Foreign Application Priority Data
Oct. 29, 2003 (EP) 03 024 937.9

(51) Int. Cl. B32B 1/08

(52) U.S. Cl. 428/36.91

(57) ABSTRACT

Exemplary embodiments of the invention provide a plastic conduit or pipe having a free conduit cross-section, in particular for accommodating feeds, the free conduit cross section including multiple layers, wherein a first layer is formed from PVC, a second layer is made of a polymer and a bonding agent layer is arranged between the first and second layers.

### CROSS REFERENCE TO RELATED APPLICATIONS

This application claims priority under 35 U.S.C. §119 to European Application 03 024 937.9 filed in Europe on 29 Oct. 2003, the entire contents of which are hereby incorporated by reference in their entirety.

### BACKGROUND

1. Technical Field

A plastic conduit and a method for manufacturing such a plastic conduit.

2. Description of the Related Art

Various types of plastic conduits are known in the prior art, including a free conduit cross-section, for instance plastic pipes having a free conduit cross-section, which are used to accommodate electrical conduits, liquid conduits and the like, in order to protect said conduits and/or, in the event of liquid escaping from the accommodated liquid conduits, in order to retain the liquid. In order to be able to manufacture such plastic conduits or pipes commercially, corresponding hollow bodies which establish a free conduit cross-section, are manufactured from low-price raw materials which have the necessary stability. In addition, it is desirable to introduce the feeds, which are to be inserted into said free conduit cross-sections, over large distances without any appreciable resistance. Corresponding plastic conduits or pipes have been manufactured from polymers, but these are relatively costly exhibit problems because inserting such polymer feeds has only been possible over short distances and/or has required a significant application of force due to an appreciable resistance to movement, which has allowed many rejects to occur.

Very cost-effective materials, such as for example polyvinyl chloride (PVC), have not been used since polyvinyl chloride has a very high resistance to movement which in practice does not allow feeds to be commercially inserted. This is particularly unfortunate, since PVC is very cost-effective and also very resistant to mechanical stresses.

Attempts to coat a PVC layer with a plastic material which exhibits a low resistance to movement have hitherto been very unsatisfactory, since it has been hardly or not at all possible to bond said polymers having a low resistance to movement to the surface of the PVC, said polymers having detached themselves again over a short period of time.

### SUMMARY

An exemplary embodiment of the present invention provides a plastic conduit or pipe including a free conduit cross-section, in particular for accommodating feeds, and including multiple layers which hardly exhibit or do not at all exhibit the aforementioned disadvantages of the prior art.

An exemplary method is provided for manufacturing a plastic conduit, using which a plastic conduit or pipe can be manufactured which at least reduces but preferably hardly exhibits or does not at all exhibit the aforementioned disadvantages of the prior art.

An exemplary embodiment of the invention includes a first layer made of PVC, a second layer made of a polymer and an intermediary layer made of a bonding agent. It should be noted that, if the plastic conduit or pipe in accordance with the invention is itself to be fed into another pipe, in exemplary embodiments the outer or shell layer can be made of a polymer having a low resistance to movement, and the inner layer can be made of cost-effective and mechanically resistant PVC or rigid PVC (e.g., PVC-U). In exemplary embodiments of the invention, a bonding agent layer is provided between layers (e.g., polymer and PVC) which otherwise do not bond to each other.

In accordance with an exemplary embodiment, the bonding agent layer can for example include ethylene vinyl acetate (EVA) or ethylene ethyl acrylate (EEA) or a mixture of these. The bonding agent layer can be any any suitable plastic adhesive.

By using the bonding agent layer, it is surprisingly possible to bond a PVC layer to a plastic layer of another polymer and vice versa.

In this way, the advantages of the plastic polyvinyl chloride and in particular of rigid polyvinyl chloride can be permanently combined with other polymers, in order to be able to use the mechanical properties of PVC and the cost-effective material PVC for plastic conduits or pipes, for accommodating feeds.

Additional advantages may be achieved by augmenting the inner layer—in the case of a plastic conduit or pipe in which feeds are to be accommodated—with supplement materials which reduce the resistance to movement, e.g., which reduce friction. If the plastic conduit in accordance with the invention is itself to be fed, i.e. if a smooth outer or shell layer is required, then if the inner layer is made of PVC, the cited supplement material can also correspondingly be admixed to the outer or shell layer, in order to reduce the resistance to movement.

In accordance with exemplary embodiments of the invention, the plastic conduit can be formed as a smooth-walled plastic conduit or pipe and/or as a corrugated plastic pipe. The shape of the plastic conduit itself can be freely selected and the conduit or pipe in accordance with exemplary embodiments of the invention can be slit, formed ovally, formed ovally and slit, and/or can include shaped supports and shaped connector areas of any type.

In accordance with an exemplary method for manufacturing a plastic conduit or pipe including multiple layers and a free conduit cross-section for accommodating feeds of any type or also for feeding into other support pipes or conduits, the following steps are performed: in respective extruders, respective plastic materials are plasticized in order to form respective plastic layers; the plasticized plastic materials are conveyed to a multi-layer injection head and arranged in a predetermined layer sequence to form the plastic conduit or pipe, wherein a PVC plastic material, for example PVC-U, is used for a first layer, a sliding polymer is used for a second layer, and a bonding agent layer is used for an intermediary layer between the first layer and the second layer.

The materials for the bonding agent layer can be those already mentioned above. In an exemplary embodiment polyethylene is used as the sliding polymer, and can be used together with one or more supplement materials which promote its sliding properties, e.g. silicone, graphite, talc, polytetrafluoroethylene, and/or molybdenum sulfide.

In an exemplary manufacturing method, three extruders are arranged for plasticizing the necessary plastics for three layers. The various plastic materials are then supplied to an injection head which arranges the three layers in the desired sequence with respect to each other, in order to create a substantially cylindrical body which can be thermoplastically deformed. Other layers can of course also be arranged in accordance with exemplary embodiments of the invention.

In an exemplary method, the three layers in question, including a PVC layer, a bonding agent layer and a layer on the other side of the bonding agent layer, are manufactured using other shapes. In an exemplary method, an injection head is provided which does not manufacture a hollow body, but manufactures profiles or the like via a corresponding outlet jet. In this way, for instance, cable pit profiles or the like can be manufactured, which do not form a cylindrical hollow body directly after manufacture, but which do provide particularly good sliding properties paired with a significant resistance and low costs.

Once the shape which is predetermined for the plastic conduit in accordance with exemplary embodiments or methods of the invention has been created, the layer sequence including PVC, a bonding agent layer and a layer made of a sliding polymer, can be manifested by cooling. In this way, smooth-walled pipes can be manufactured. If corrugated pipes or pipes with other profiles are to be manufactured, this can be achieved using a corrugator. Corrugators and injection heads are sufficiently known and do not need to be discussed further here. Merely by way of example, reference is made to DE 101 10 084.1 and DE 100 62 590.8, which show examples of an injection head and a corrugator.

The layer sequence provided by exemplary embodiments of the invention can be used in a variety of ways, for example by coating a highly resistant layer made of PVC on both sides with bonding agent and on both sides with a layer made of a sliding polymer, if for instance feeds are to be inserted into a corresponding pipe, wherein the pipe itself in turn forms a feed with respect to a pipe having a larger diameter.

### BRIEF DESCRIPTION OF THE DRAWING

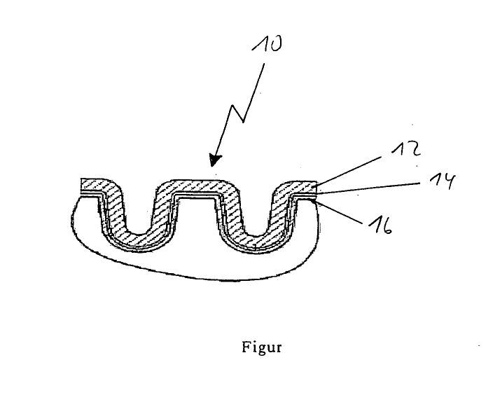

Exemplary embodiments of the present invention are described in more detail below with reference to the enclosed FIG. 1, which shows a partial sectional representation of a plastic conduit, in a partial longitudinal section.

### DETAILED DESCRIPTION

A pipe section 10 as shown includes three layers 12, 14, 16 made of different materials.

One layer 12 is formed from PVC, for example PVC-U. One layer 14, which is directly applied to the layer 12, is formed from a bonding agent, for example a plastic adhesive. The bonding agent is in turn coated with a sliding polymer 16.

While the layer 14 can for example consist of EVA and/or EEA, the layer 16 is can be made of polyethylene.

The layer made of polyethylene can additionally be augmented with additional material, to reduce the resistance to movement which could for example occur with respect to a feed. Silicone, graphite, talc, polytetrafluoroethylene and molybdenum sulfide can for example be used as additional materials.

In the foregoing description, an exemplary embodiment of the invention has been presented for the purpose of illustration and description. It is not intended to be exhaustive or to limit the invention to the precise form disclosed. Obvious modifications or variations are possible in light of the above teachings. The embodiment was chosen and described to illustrate principles of the invention and practical applications of the invention, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A plastic conduit comprising a free conduit cross-section, in particular for accommodating feeds, the free conduit cross-section including a first layer made of polyvinyl chloride PVC and a second layer comprising a polymer, wherein a bonding agent layer is arranged between said first layer and said second layer.

2. The plastic conduit as set forth in claim 1, wherein the first layer is a shell layer and the second layer is an inner layer.

3. The plastic conduit as set forth in claim 1, wherein the first layer is an inner layer and the second layer is a shell layer.

4. The plastic conduit as set forth in claim 1, wherein the first layer is made of rigid PVC (PVC-U).

5. The plastic conduit as set forth in claim 1, wherein said bonding agent layer includes at least one of the following plastic materials: ethylene vinyl acetate (EVA); ethylene ethyl acrylate (EEA).

6. The plastic conduit as set forth in claim 1, wherein the second layer is augmented with a supplement material which reduces a resistance to movement on the free surface of the second layer.

7. The plastic conduit as set forth in claim 1, wherein the plastic conduit is formed as a smooth-walled plastic conduit or pipe.

8. The plastic conduit as set forth in claim 1, wherein the plastic conduit is provided with a profile.

9. The plastic conduit as set forth in claim 1, wherein the plastic conduit is corrugated.

10. The plastic conduit as set forth in claim 1, wherein the plastic conduit is arranged to accommodate feeds.

11. A method for manufacturing a plastic conduit and/or pipe comprising various layers and a free conduit cross-section, the method comprising:
in respective extruders, plasticizing respective plastic materials in order to form respective plastic layers;
conveying said plasticized plastic materials to a multi-layer injection head and arranging said plasticized plastic materials in a predetermined layer sequence to form the plastic conduit or pipe;
wherein:
a PVC plastic material is used for a first layer;
a sliding polymer is used for a second layer; and
a bonding agent layer is used for an intermediary layer between the first layer and the second layer.

12. The method as set forth in claim 11, wherein one of the following materials is plasticized as said plastic material for said bonding agent layer: ethylene vinyl acetate (EVA); ethylene ethyl acrylate (EEA).

13. The method as set forth in claim 12, wherein the plastic conduit or pipe is formed or cooled with a smooth-walled shape.

14. The method as set forth in claim 11, wherein the plastic conduit or pipe, which may be thermoplastically deformed, is supplied to a corrugator and in said corrugator is provided with a shape, for instance a corrugated shape, support shape and/or the like.

15. The method as set forth in claim 11, wherein PVC-U, is used for the first layer and polyethylene is used for the second layer.
